(19) United States
(12) Patent Application Publication
(10) Pub. No.: US 2002/0057478 A1
(43) Pub. Date: May 16, 2002

(54) System and transmitter for transmitting optical data

(75) Inventors: Hans Bissessur, Paris (FR); Denis Penninckx, Nozay (FR)

Correspondence Address: SUGHRUE MION, PLLC, 2100 Pennsylvania Avenue, NW, Washington, DC, 20037-3213, US

(73) Assignee: ALCATEL

(21) Appl. No.: 09/983,961

(22) Filed: Oct. 26, 2001

(30) Foreign Application Priority Data
Oct. 27, 2000 (EP) 00 440 289.7

(51) Int. Cl. H04B 10/04

(52) U.S. Cl. 359/183; 359/180

(57) ABSTRACT

A transmission system and a transmitter for optical signals is proposed with a laser and a modulator for modulating the signal by supplying a controlled phase optical signal having optical power modulated between low levels and high levels respectively corresponding to said first and second modulation levels of the input signal, and a phase shift within each time cell that contains a low power level and which precedes or succeeds a cell that contains a high power level and an optical pass band filter that filters the modulated signal.

The invention relates to the field of transmitting digital data by optical means. It is more particularly concerned with transmission at high bit rates on long-haul fiber optic links using a PSBT (Phase Shaped binary Transmission) modulation scheme and a transmitter that can modulate the data in a optimal form.

### BACKGROUND OF THE INVENTION

Such transmission uses an optical transmitter connected to an optical receiver by the fiber. The transmitter generally modulates the power of an optical carrier wave from a laser oscillator as a function of the information to be transmitted. NRZ or RZ modulation is very frequently used and entails varying the power of the carrier wave between two levels: a low level corresponding to extinction of the wave and a high level corresponding to a maximum optical power. The variations of level are triggered at times imposed by a clock rate and this defines successive time cells allocated to the binary data to be transmitted. By convention, the low and high levels respectively represent the binary values “0” and “1”.

The maximum transmission distance is generally limited by the ability of receivers to detect without error these two power levels after the modulated wave has propagated in the optical link. The usual way to increase this distance is to increase the ratio between the average optical power of the high levels and that of the low levels, this ratio defining the “extinction ratio” which is one of the characteristics of the modulation.

For a given distance and a given extinction ratio, the information bit rate is limited by chromatic dispersion generated in the fibers. This dispersion results from the effective index of the fiber depending on the wavelength of the wave transported, and it has the consequence that the width of the transmitted pulses increases as they propagate along the fiber.

This phenomenon is characterized by the dispersion coefficient D of the fiber, which is defined as a function of the propagation constant β by the equation D=−(2πc/λ²)d²β/dω², where λ and ω are respectively the wavelength and the angular frequency of the wave.

The value and sign of the dispersion coefficient D depend on the type of fiber and the transmission wavelength. For example, for the “standard” monomode fibers routinely used, and for λ=1.55 μm, the coefficient D is positive and has a value of 17 ps/(nm.km). In contrast, the coefficient D is zero for λ=1.30 μm. The coefficient D can generally be positive, zero or negative depending on the wavelength and the type of fiber used.

If the coefficient D has a non-zero value, to compensate the phenomenon of pulse widening in the case of NRZ or RZ modulation, it has already been proposed to modulate the phase φ (and therefore the frequency or the angular frequency) of the carrier wave in a manner that correlates to the modulation of the power. The phase φ corresponds to the convention whereby the electric field of the carrier wave is represented as a function of time t by a complex expression of the type: Ap exp (jωₒt) and the field of a transmitted wave S of amplitude A is represented by: S=A exp [j(ωₒt+φ)], where ωₒ is the angular frequency of the carrier wave and φ is the phase of the transmitted wave.

To be more precise, to compensate chromatic dispersion, and if the coefficient D is positive, the phase must decrease on the rising edges of the pulses and increase on their falling edges. The modulated wave is then said to feature a transient negative “chirp”. If, in contrast, the coefficient D is negative, the phase modulation must be reversed and the transient “chirp” is positive.

A transient “chirp” parameter a is introduced to characterize this modulation, and is defined by the equation α=2P(dφ/dt)/(dP/dt), where P is the power of the modulated wave and φ is its phase in radians.

For the previously mentioned standard fibers and for values of k close to 1.55 μm, for example, the value of the parameter α must be constant and substantially equal to −1 if by approximation α is regarded as constant.

Another approach proposes to reduce the bandwidth of the signal to be transmitted by appropriate encoding. One particular proposal is to use the “duobinary” code which is well-known in the field of electrical transmission. This code has the property of halving the bandwidth of the signal. According to the standard definition of this code, a signal is used with three levels respectively symbolized by 0, + and −. The binary value 0 is encoded by the level 0 and the value 1 is encoded either by the level + or by the level − with an encoding rule whereby the levels encoding two successive blocks of “1” around a respectively even or odd number of successive “0” are respectively identical or different.

Using the duobinary code for optical transmission is mentioned in the article “10 Gbit/s unrepeatered three-level optical transmission over 100 km of standard fiber”, X.Gu et al., ELECTRONICS LETTERS, Dec. 9, 1993, Vol.29, No.25. According to the above article, the three levels 0, +, − respectively correspond to three levels of optical power.

The U.S. Pat. No. 5,867,534 also describes application of duobinary encoding to the optical field. In the above document, binary “0” always corresponds to a low level of the optical power and the symbols + and − correspond to the same high optical power level and are distinguished by a 180° phase-shift of the optical carrier.

The use of that phase inverting duobinary code is also mentioned in the article “Optical duobinary transmission system with no receiver sensitivity degradation”, K, Yonenaga et al., ELECTRONICS LETTERS, Feb. 16, 1995, Vol.31, No.4.

In simulations and tests in which the experimental parameters were varied, it was found that an improvement is obtained provided that a phase shift of the carrier wave occurs within each “0” which precedes or succeeds each block of “1” or each isolated “1”. The absolute value of the phase shift can be approximately 180°. Also, the average optical power of the low levels which encode “0” must have a value relative to that of the high levels sufficient to create intersymbol interference favorable to compensating chromatic dispersion. This amounts to saying that the extinction ratio must have a finite value.

The above observations have lead to the definition of a new optical transmission method known as Phase-Shaped Binary Transmission (PSBT). This method is described in European Patent Application EP-A-0 792 036 (Application No. 97400345.1), for example.

The PSBT process requires a transmitter capable of applying an absolute phase shift in the order of 180° to the carrier wave within each cell that corresponds to logic “0” and which precedes or succeeds any cell containing a logic “1”.

A solution using a laser oscillator coupled to an electro-optical power modulator in turn coupled to an electro-optical phase modulator, for example, has the drawback of requiring complex and costly electronic control.

In reality, it is not at all inconvenient for the phase shifts to be effected systematically in each cell containing a logic “0”. This leads to a simpler implementation using a “Mach-Zehnder” interferometer modulator. A modulator of this kind comprises an interferometer structure with an input optical guide that splits into two branches that are combined to form an output guide. Electrodes apply respective electric fields to the two branches. When the input optical guide receives a carrier wave of constant power, two partial waves propagate in the two branches and then interfere at the output. The output guide then supplies a wave whose power and phase depend on the values of the electrical control voltages applied to the electrodes. Phase shifts of approximately 180° can be produced at the times when the instantaneous power of the transmitted wave is zero.

To satisfy the conditions for PSBT modulation, the electrical control system must firstly feature amplitude modulation at three main levels as a function of the signal to be sent, in accordance with the duobinary code. It must also feature sustained oscillation at a low amplitude during consecutive sequences of “0”. The electrodes must therefore be biased so that in the absence of modulation the DC components of the applied electrical voltages are such that the interference of the two partial waves is as destructive as possible.

If the modulated control signal is applied to only one of the electrodes and the other electrode receives a fixed bias voltage, the optical signal output by the modulator features a non-zero transient “chirp” which can be positive or negative, depending on the sequence of binary data encountered and whether the edge is a rising or falling edge.

One solution to the problem of eliminating that uncontrolled transient “chirp” is to use “push-pull” control applying a modulated voltage to one of the electrodes, as previously indicated, and a modulated voltage with the opposite phase to the other electrode.

Tests on standard fibers have shown that PSBT modulation achieves transmission distances much greater than those that can be attained with NRZ or RZ modulation. For example, a 10 Gbit/s signal can be transmitted 240 km, although the limit with NRZ modulation is only around 70 km.

However, implementations of PSBT modulators, especially those with an interferometer structure as mentioned above, do not always guarantee optimum transmission quality, regardless of their operating conditions.

For example, long-haul transoceanic transmission optical links include many amplifiers. The noise generated by the amplifiers then seriously degrades the extinction ratio. It is then useful to be able to adjust the extinction ratio at the transmitter end to give it an optimum value, i.e. a value high enough to allow for the amplifiers but low enough for intersymbol interference to compensate widening of the pulses due in particular to chromatic dispersion. An adjustment of this kind is difficult to implement in the control function of PSBT modulators, however.

Studies have shown that with PSBT modulation transmission distances can be increased by introducing a transient “chirp” whose sign and optimum value depend in particular on the dispersion coefficient D of the fiber, on the required transmission distance, and on non-linear effects (Kerr effect). As previously mentioned, the interferometer modulator solution cannot readily impose a transient “chirp” of given sign and value.

In the application EP 99 401 808.3 it is proposed a transmission system which is more flexible to use and which is easier to optimize for each type of optical link and for each transmission distance.

The transmission system includes a first electro-optical modulator adapted to supply in response to an input electrical signal a controlled phase optical signal having an optical power modulated between low levels and high levels and a phase shift within each time cell that contains a low power level. To make it more flexible to use, the system includes a second electro-optical modulator controlled by the input signal and optically coupled to the first electro-optical modulator to apply to said controlled phase optical signal complementary power and/or phase modulation so as respectively to modify its extinction ratio and/or to apply a transient “chirp” to it.

This kind of structure requires a synchronous driving of the two modulators. The modulation must be established channel by channels which increases the number of expensive components.

The invention allows a good resistance to chromatic dispersion and to noise. The eye opening of the signals transmitted with the inventional arrangement is improved in comparison with the basic PSBT modulation scheme. The eye opening of the inventional PSBT modulation scheme and the extinction ration is increased by about 3 dB.

### DRAWINGS

FIG. 1 shows an schematic structure of transmitter

FIG. 2 shows the spectrum of the PSBT

FIG. 3 shows the resulting eye opening

FIG. 4 shows the variation of Q

FIG. 5 a bit error rate diagram

FIG. 6 WDM structure.

### DESCRIPTION OF THE INVENTION

FIG. 1 shows a transmitter for optical signals. The transmitter includes a laser 2 , the output of the laser 2 is connected to a modulator 3. The output of the modulator 3 is fed to the input of an optical filter 4. The output of the optical filter 4 is connected to the transmission line 5.

The cw signal of the laser 2 is modulated by the modulator 3. This modulator can be realized as an electro absorption modulator or a Mach-Zehnder modulator. The modulator is in detail described in the application EP-A-0 792 036 which should be part of the description of this application.

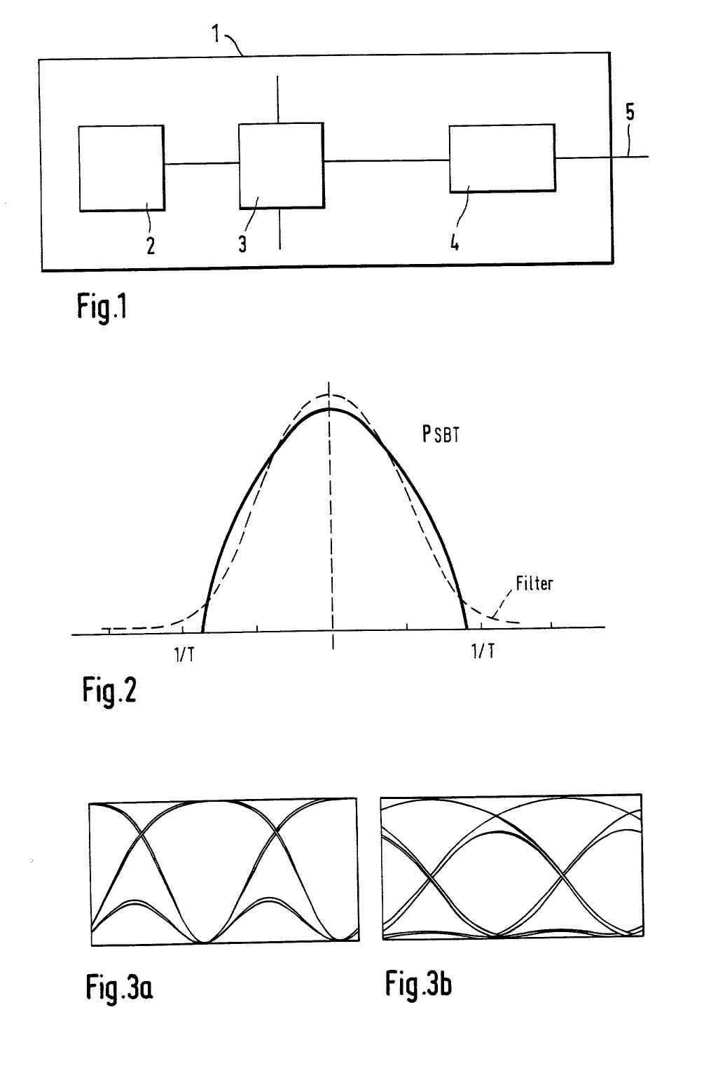

After modulating the signal the optical signal is limited by a band pass filter 4. As shown in FIG. 2 the band pass filter is centered in f₀ which is the carrier wavelength of the signal. The filter shape follows a smooth filter curve. This can be realized either by a Gaussian shape of the filter or a sin² filter curve or any other filter shape that can be used for a bandpass filter. As one embodiment of the invention a rectangular filter shape as realized by a fiber Bragg grating is used.

FIG. 3 shows the advantages of a limited filtering of the optical signal. 3a) shows the eye diagram of a PSBT signal without any filtering. This diagram shows bounces in the “0” signals which reduces the eye opening and the related Q-factor of the transmission system. FIG. 3b) shows the eye diagram after the optical signal is filtered by a narrow Gaussian filter with a width 1/e=1.2/T. The bounces are damped dramatically and the eye opening increases.

FIG. 4 shows the resulting Q-factor over the width of the optical filter in GHz. The Q-factor increases from a value about 0.6 for a broad filter width to a value over 0.7 by decreasing the width of the optical filter. So in contradiction to the prejudice of persons skilled in art the quality of the signal can be improved by a narrowing of the bandpass filter. The narrowing is for sure limited and it can be derived from FIG. 4 that for very narrow filter widths the quality decreases dramatically. An optimum quality can be achieved by using a filter width of 0.8/T to 1.8/T where T is the bit period time.

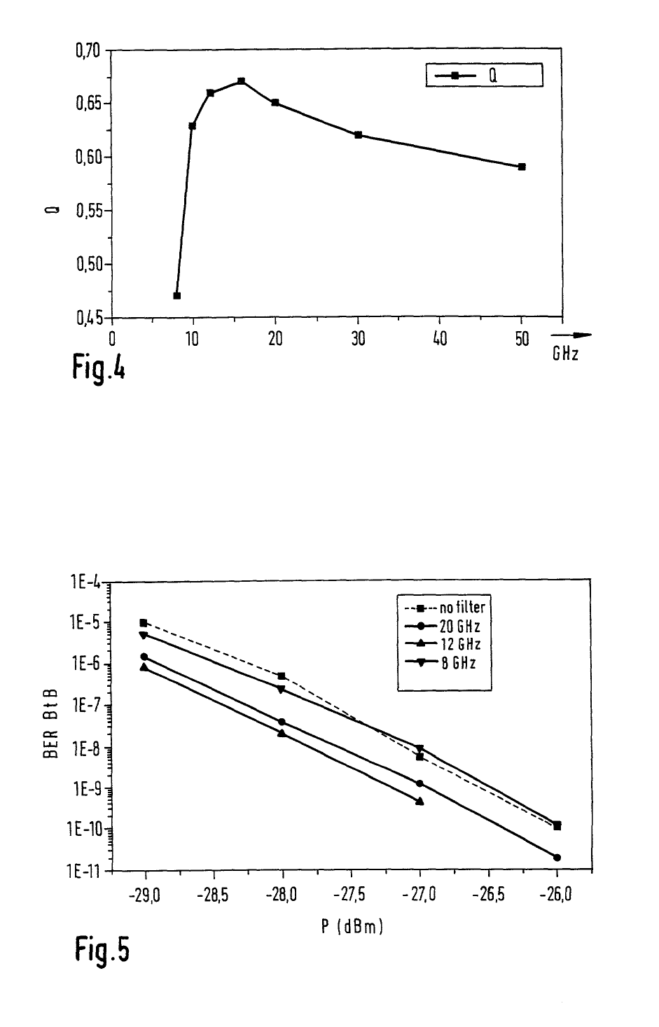

FIG. 5 shows that the bit error rate (BER) over the power of the signal. It can also derived from this chart that a optical filter width with 1.2/T improves thee bit error rate behavior of the transmission system.

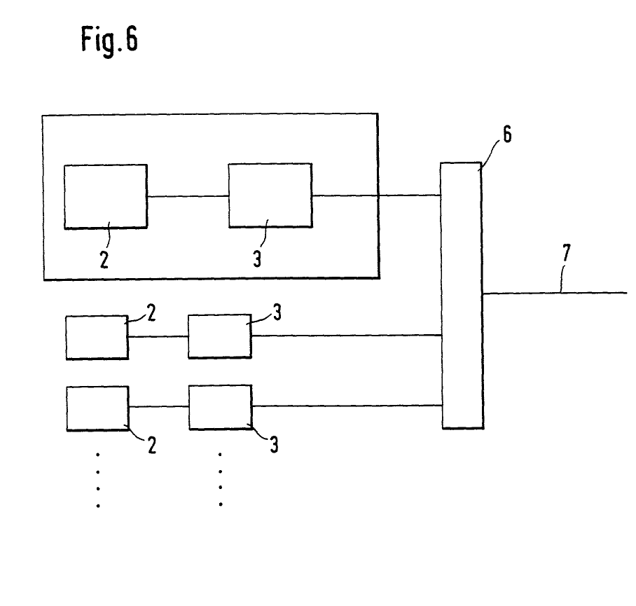

An further embodiment of the invention is described in FIG. 6. A laser 2 is connected to a modulator 3 for each channels of a wavelength multiplex. Afterwards the single optical signals are multiplexed in a multiplexer 6.

For a WDM transmission system a number optical signals of different wavelengths are grouped in a multiplexer. The multiplexer itself has a natural filtering function realized for example with an arrayed waveguide grating (AWG). The spectral response of a AWG narrows the bandwidth of the modulated signal and is similar to a smooth shaped band pass filter.

So in this embodiment the AWG is used for two functions: to multiplex data in one data stream for transmission and to limit the bandwidth of the single channels by the internal filtering function.

1. A system for transmitting an optical signal in the form of an optical carrier wave modulated as a function of an input binary electrical signal, said device including an electro-optical modulator adapted to respond to said input electrical signal by supplying a controlled phase optical signal having optical power modulated between low levels and high levels respectively corresponding to said first and second modulation levels of the input signal, and a phase shift within each time cell that contains a low power level and which precedes or succeeds a cell that contains a high power level,
characterized in that an optical narrow band pass filter is integrated.

2. A transmitter for optical signals with a laser and a modulator for modulating the signal by supplying a controlled phase optical signal having optical power modulated between low levels and high levels respectively corresponding to said first and second modulation levels of the input signal, and a phase shift within each time cell that contains a low power level and which precedes or succeeds a cell that contains a high power level
characterized that an optical narrow pass band filter filters the modulated signal.

3. A transmitter according to claim 2 where the band pass filter is centered at the carrier wavelength.

4. A transmitter according to claim 2 where the band pass filter has a Gaussian shape.

5. A transmitter according to claim 4 where the band pass has a bandwidth between 0.8/T to 2,5/T with T equal to the bit time of the signal.

6. A transmitter according to claim 2 where the electro-optical modulator includes:
a “Mach-Zehnder” interferometer structure wherein an input optical guide splits into two branches to guide two partial waves, said two branches combining again to form an output guide, respective electrodes being provided to apply electrical fields to said two branches, and
a control circuit for applying to the electrodes respective control voltages having DC components between modulation components in phase opposition, said DC components being such that in the absence of modulation components said partial waves interfere destructively.

7. A transmitter for a WDM system with a laser, a modulator and a connection to a multiplexer structure, the multiplexer structure has a filtering function for the optical signal.
